(19) United States
(12) Patent Application Publication
(10) Pub. No.: US 2015/0100381 A1
(43) Pub. Date: Apr. 9, 2015

(54) Method and System for Increasing the Percentage of Customers Realized from Smart Phone Advertising

(71) Applicants: Douglas Petrie, Ramsey, NJ (US); Douglas Tubbs, Gulf Breeze, FL (US)

(72) Inventors: Douglas Petrie, Ramsey, NJ (US); Douglas Tubbs, Gulf Breeze, FL (US)

(21) Appl. No.: 14/045,753

(22) Filed: Oct. 3, 2013

(51) Int. Cl. G06Q 30/02

(52) U.S. Cl. CPC G06Q 30/0241; G06Q 30/0203
USPC 705/7.32

(57) ABSTRACT

A computerized method directed at smart phone users, that includes the step of utilizing a networked, computer device and software to provide “engagement services” via the video screens of the users' smart phones, can yield higher rates of customer conversions by configuring the computer device's software to provide: (a) a specialized interface that appears on the video screens of such smart phones, (b) prepared questions that appear on this interface and which are used in a dialog with a smart phone user to elicit the information necessary to establish the sales lead data of the smart phone user, (c) a real-time validation of the elicited information, and (d) prepared, follow-up responses, dependent upon the outcome of such validations, that also appear on the interface and which are provided so as to foster the continuation of the dialog and the collection of the necessary information.

### BACKGROUND OF THE INVENTION

1. Field of the Invention

The present invention relates generally to telecommunications. More particularly, the present invention enables smart phone advertisers to increase the percentage of customers that they realize as a result of such advertising.

2. Description of the Related Art

Most product and service suppliers use one or more websites on the internet and various product/service-related downloadable apps to advertise, promote and sale their products and services and provide a customer services function. While this form of electronic commerce (i.e., e-commerce) and such websites and apps have enjoyed great success and continue to proliferate on the internet, there are always ongoing efforts in the e-commerce industry to improve upon the performance of these websites.

For example, various “cloud computing” or software-as-a-service providers have recently come forth with an assortment of methods and systems to improve the sales capabilities and customer service aspects of networked websites, etc. These improvements include providing what we'll herein refer to as “online or chat engagement services,” and which we define as “engaging website visitors and others by offering them the opportunity to establish a live or real-time connection to a sales and/or customer service representative or agent for the purposes of chatting (i.e., textual, audio or audio & visual) to try to increase the usefulness of the website, etc. to its visitors.” See, for example, the information regarding these services on the “online or chat engagement services provider” websites of LivePerson.com, BoldChat.com, Zopim.com and Olark.com.

The sophistication of the service offerings of these “online or chat engagement services” providers have significantly increased over the past few years. The first “online or chat engagement” methods in this field consisted of an “inbound-only” approach that consisted of placing a “click-to-chat” or similar buttons (e.g., click-to-talk, click-to-talk-with video) on the website provider's or business owner's “Contact Us” or “Customer Service” pages and waiting for website visitors and potential customers to initiate a live dialogue with one who is a representative of the business or website owner (e.g., an employee of a contract center that the business owner has contracted with to answer such chat inquiries).

There were many disadvantages with this method of operation, including: (a) the inability to tie the availability of a “click-to-chat” button with the availability of a representative who was responsible for answering such chat inquiries, and (b) since any website visitor could initiate a chat, there was no way to try to discriminate between those requesting chats so as to be able to answer first the chat requests of those who were most likely to become customers or were already customers and needing customer service support—i.e., there was no way to most wisely and productively use the time of the chat answerer or representative.

The initial improvements to this “inbound-only” approach were to provide website providers and/or business owners (also contact center operators) with options for how they might engage with a website visitor so that they could target, specific website visitors. These options included: (a) providing “click-to-chat” buttons on only what the website provider identifies as its high-priority webpages, and (b) proactively and automatically, based upon established and somewhat arbitrary rules which were meant to increase the effectiveness of the website, sending chat invitations to a selected few of the website's visitors.

A more recent improvement in the industry of the “online or chat engagement service” providers includes the introduction of improved software that monitors and analyzes in great detail all website visitors' activities on a particular website (i.e., the website of the client or one who is employing the services of an “online or chat engagement” service provider) and uses this information to formulate, statistically-defined rules that predict when a population of website visitors or potential customers act on the website in a certain manner (e.g., linger on the “place order” page for more than 60 seconds) that a large percentage of this population will consequently take a predicted desirable action (e.g., with assistance from a chat agent, place an order and thus become a customer). These rules are then used to write improved software programs or algorithms that utilize the real-time data that is being collected regarding a visitor's activities on a website to determine when and if this website visitor should be offered an invitation to chat with the website's agent/s so as to most productively: (a) use the available time of the agents who are tasked with answering the chat inquiries of the website's invitees, and (b) yield the most productive outcome for the website visitors.

With the ever increasing popularity of mobile devices, such as tablet computers and handheld computing devices (e.g., smartphones) having smaller display screens and wireless capabilities that allow connection to the internet, and the resulting rapid growth of mobile commerce (i.e., electronic commerce conducted wirelessly anywhere via one's mobile device), “online chat engagement service” providers have recently extended their offerings to provide their services to mobile devices. More particularly, “online chat engagement service” providers now provide their services to those product or service suppliers who have configured their websites to be “wireless portals” that can be optimally viewed on the smaller display screens of mobile devices while being accessed by the mobile browsers of these devices.

While these “online chat engagement service” industry improvements have reportedly yielded profitability improvements for the business owners who employ such service providers, there is still a needs for further improvements in this service industry—improvements such as higher (website-visitor- or chatter-to-customer) conversion rates (note: the e-commerce industry average is reportedly only 2-5 percent), higher sales volumes, reductions in the ratio of advertising costs to revenue earned, and increases in customer service satisfaction levels.

### SUMMARY OF THE INVENTION

Recognizing the need for the development of improvements in the methods and the services directed to desktop, internet-accessible computers and mobile devices by “online or chat engagement service” providers (i.e., one who provides the service that enables a desktop computer or smart phone user to chat regarding computer and smart-phone-accessible advertisements, etc.), the present invention is generally directed to fulfilling these needs.

According to the present invention, a computerized method directed at desktop, internet-accessible computer and/or smart phone users, that includes the step of utilizing a networked, computer device and software to provide such engagement services via the video screens of the users' computers and smart phones, can be improved upon, so as to yield higher rates of customer conversions for business entities who advertise products or services to such computer and smart phone users, by configuring the computer device's software to provide: (a) a specialized interface that appears on the video screens of such computers and smart phones, (b) prepared questions that also appear on this interface and which are used in a dialog with the user to elicit from user the information necessary to establish the sales lead data of the user, (c) a real-time validation of the elicited information, and (d) prepared, follow-up responses, dependent upon the outcome of such validations, that also appear on the interface and which are provided so as to foster the continuation of the dialog and the collection of the necessary information.

A variant of the present invention can include further configuring this software so as to create a business entity or client-interface, wherein it's recognized that a business entity utilizing this method is a client of provider of such engagement services, that enables a client to customize the prepared questions and follow-up responses so as to meet a client's needs for differing types of information.

Another variant of the present invention can also include configuring this software so as to enable a client to utilize this client-interface so as to customize a multi-day, at-specific-hours/day campaign that is conducted using this improved method to collect a large quantity of such sales lead data.

Yet another variant of the present invention can also include configuring this software so as to: (a) enable a user to utilize his/her specialized interface to conduct a live-chat with an agent of the business entity or client, and (b) create an agent-interface for use on the method's computer device that enables this agent to participate in such live chats.

An additional variant of the present invention can also include configuring this software so as to enable a client to utilize the client-interface to customize the method's agent-interface so as to aid the agent in participating in such live chats.

A still further variant of the present invention can include configuring the method's software so that the previously mentioned customization of the agent-interface: (a) aids the agent in simultaneously chatting with a number of such users, and (b) during these simultaneous chats, keeps the agent abreast of the status of the progress towards collecting the information necessary to establish the sales lead data for each of the users.

Thus, there has been summarized above (rather broadly and understanding that there are other preferred variants which have not been summarized above) the present invention in order that the detailed description that follows may be better understood and appreciated.

### BRIEF DESCRIPTION OF THE DRAWINGS

FIG. 1 is a block diagram that provides a simplified system overview of the type of “engagement service” system and its operating environment where the improvements provided by the present invention would be implemented.

FIG. 2 shows a computer monitor, screen shot that is provided by the agent-portion of the software of the present invention; it provides an agent with numerous tools that are meant to aid an agent in capturing sales lead data.

FIG. 3 shows a smart phone's screen shot that is provided by the agent-portion of the software of the present invention; it provides an agent with tools that are meant to aid an agent in capturing sales lead data.

FIGS. 4-6 presents three example of customer-interfaces that are presented on a smart phone whose user is communicating with the engagement service provider by using the phone's browser to view a service-provider-generated web pages.

FIG. 7 is a flow diagram that generally illustrates how the software of the present invention works to make the agents of “engagement service” providers more productive by better enabling them to efficiently collect sales lead information for their clients who are the marketers of various products and services.

FIG. 8 is a flow diagram which shows the various steps in a lead generation process or campaign from the perspective of the smart phone chatter or potential customer for the products and services being marketed by the client's of the “engagement service” provider.

FIG. 9 shows another screen shot provided by the client-interface portion of the software of the present invention; it provides an aid that can be used by a client or system administrator in setting up or customizing the tools that will be used in a specific sales lead generation campaign.

FIG. 10 shows a client-interface screen shot of the present invention that is for use by individual clients to create, for their personalized sales lead generation campaigns, the customized date fields that will be used in the screen shots for the customer- and agent-interfaces of such campaigns.

FIG. 11 shows a customer-interface screen shot which a customer is asked to review and confirm that the information in the screen shot is accurate.

FIG. 12 presents an example of a customer-interface screen shot that would be appropriate for a “engagement service” provider to show to a customer when no agent is available to participate in a live chat with a customer who is requesting such a chat.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the applications drawings or figures. The invention is capable of other embodiments and of being practiced and carried out in various ways. Also, it is to be understood that the phraseology and terminology employed herein are for the purpose of description and should not be regarded as limiting.

For example, the term “smart phone” or simply “phone” is used herein broadly to include, without limitation, those types of cell phones that are built on a mobile operating system with more advanced computing capability (that enable the use of a high-resolution video screen and mobile applications) and greater connectivity (i.e., a web browser) than a standard cell phone. The first smart phones combined the functions of a personal digital assistant (PDA) with a mobile phone. Many modern models include the functionality of portable media players, low-end compact digital cameras, pocket video cameras, and GPS navigation units. High-speed data access is provided by Wi-Fi, mobile broadband and mobile phone carrier data plans.

The present invention generally relates to methods and systems for “engagement service” providers to supply business entities who operate “wireless portals” or “mobile applications,” i.e., the smart phone advertisers and thus the clients of the “engagement service” provider, with improved engagement service capabilities that results in the creation of a database of verified sales leads for potential customers of the smart phone advertisers. These sales leads often take the form of the contact information for the smart phone users.

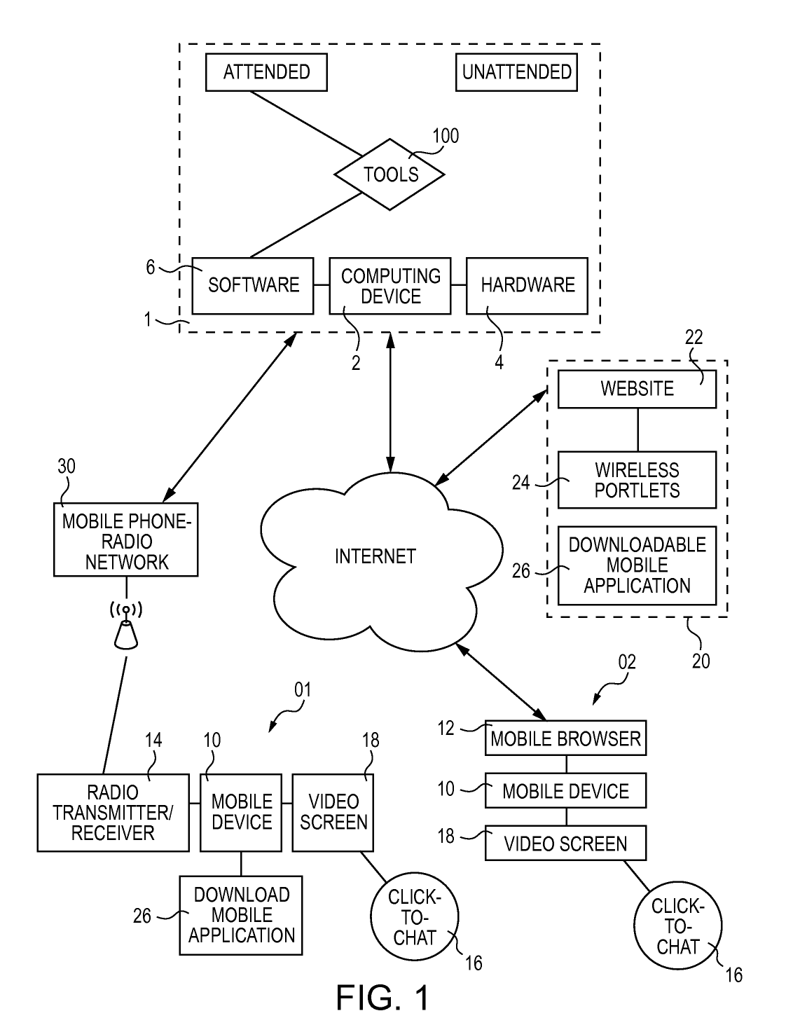

FIG. 1 provides a simplified system overview of the type of “engagement service” system 1 that would be used to implement the improvements of the present invention. It consists of a computing device (e.g., a server or smart phone) 2, with the appropriate hardware 4 and software 6, that is connected to a network (e.g., the internet or a mobile phone network) to which product or service suppliers/advertisers 20 are also directly or indirectly connected and by which they and their customers have access to the improved “engagement services” of the present invention.

As previously mentioned, the product or service suppliers 20 that the present invention is meant to serve are those which direct some of their advertising and promotional efforts to potential customers 01, 02 who use mobile devices 10—i.e., suppliers who either: (i) maintain websites 22 on the internet that are “wireless portals” 24 which the mobile browsers 12 of the smart phones can access via the internet, etc., or (ii) provide downloadable “mobile applications” 26 for installation on mobile devices to enable potential or current customers to access information or perform specific functions/tasks that are associated with the suppliers' products or services. It can be noted that such downloaded mobile applications 26 are often configured to use the mobile device's wireless phone components, radio transmitter/receiver 14, and the device's mobile phone carrier network 30 for any needed wireless communications.

To increase the effectiveness of these “wireless portals” or “mobile applications,” an “engagement service” provider who utilizes the present invention can provide customers or potential customers (i.e., customers) with both “live or attended” chat capabilities (i.e., the ability for a wireless portal visitor or a mobile application user to have a real-time chat (text, audio or audio & video) with an agent of the “engagement service” provider) and “unattended” chat capabilities (i.e., the ability for a wireless portal visitor or a mobile application user to respond to a dialog of automated textual questions that aid one in inputting personal information into a sales lead database). Customers then have the option to review their input via a programmatic post by the service provider into their own data fields, via an email or an SMS message (the SMS message is a link which opens a URL that has the information).

These “unattended” chat capabilities are an especially unique feature of the present invention. They have been found to be considerably easier and more enjoyable for customers to use than prior methods that asked the customer to complete fill-in-the-blank forms that were displayed on comparatively small video screens of most mobile devices, and which many customers consequently found difficult (e.g., due to having to scroll and click to input data into different boxes) or distasteful to complete. Meanwhile, because so many people are today very adept and comfortable with chatting (i.e., text messaging) on their mobile devices, responding in a chat format to a dialog of automated textual questions, that aid one in inputting personal information into a database, has been found in numerous customer surveys to be a much preferred means for accomplishing such data input tasks.

Additionally, it should be noted that the simplest variant of the present invention probably takes the form of an improved, computerized method of collecting any desired information from a smart phone user. Thus, current, computerized information collection methods that are applicable to smart phone users can be improved upon by configuring the operational software for these methods so that the desired information is collected using an “unattended” chat format. This requires the steps of: (a) creating a specialized dialog interface that appears on the video screens of such smart phones, (b) creating prepared questions that are to be used in an automated dialog with the smart phone user which seeks to elicit the desired information, (c) performing a real-time validation of the elicited information, and (d) creating follow-up responses, dependent upon the outcome of the validations, that are presented on the smart phone user's video screen so as to foster the continuation of the dialog and the further collection of the desired information.

In an effort to enhance the usefulness and acceptance by customers of such dialog interfaces, the software of the present invention is further configured to assess the type of phone that a customer is using so such specialized dialog interface can be formulated or especially created for the nuances, display resolution, and proprietary features of a particular customer's phone and/or browser.

Such chats may be initiated by a wireless portal visitor or a mobile application user clicking or pushing a “click-to-chat” button 16 that appears on the mobile device's video screen 18 when it is displaying a screen shot of the “wireless portal” or one generated by the “mobile application.” Alternatively, the “attended” chats may be initiated by the agent based on a website visitor's activities on the website and the subsequent issuance by the agent of an invitation to the website visitor to chat—e.g., the agent causes a “Invitation to click-to-chat” button 16 to appear on the video screen 18 of the website visitor.

A key part of ensuring that such “engagement” efforts or activities are as productive as possible is clearly seen to be: (a) for “attended” chats, the contributions of the agents who use the video screen of a computing device 2 to monitor the output of the present invention's software 6 and actually conduct these live chats, and (b) for “unattended” chats, the usefulness and format of the dialog boxes which lead one through the process of entering the information necessary to allow a supplier to re-establish contact with the customer at a later date. It is in these areas that the present invention seeks to make its greatest contributions by introducing various tools, methods and systems 100 to make such “engagement” efforts more productive.

To achieve this increased productivity for “unattended” chats, a key aspect of the present invention is the configuring of its software so that it provides: (a) a a plurality of prepared questions that are used in an automated dialog with a smart phone user to elicit the information necessary to establish the customer's or smart is phone user's sales lead data, (b) a real-time validation of the elicited information, and (c) an automated, follow-up response, which is dependent upon the outcome of the validation of the answer to a previous question, to the smart phone user for his/her input that will allow and promote the continuation of this automated dialog so that the collection of the required information may continue.

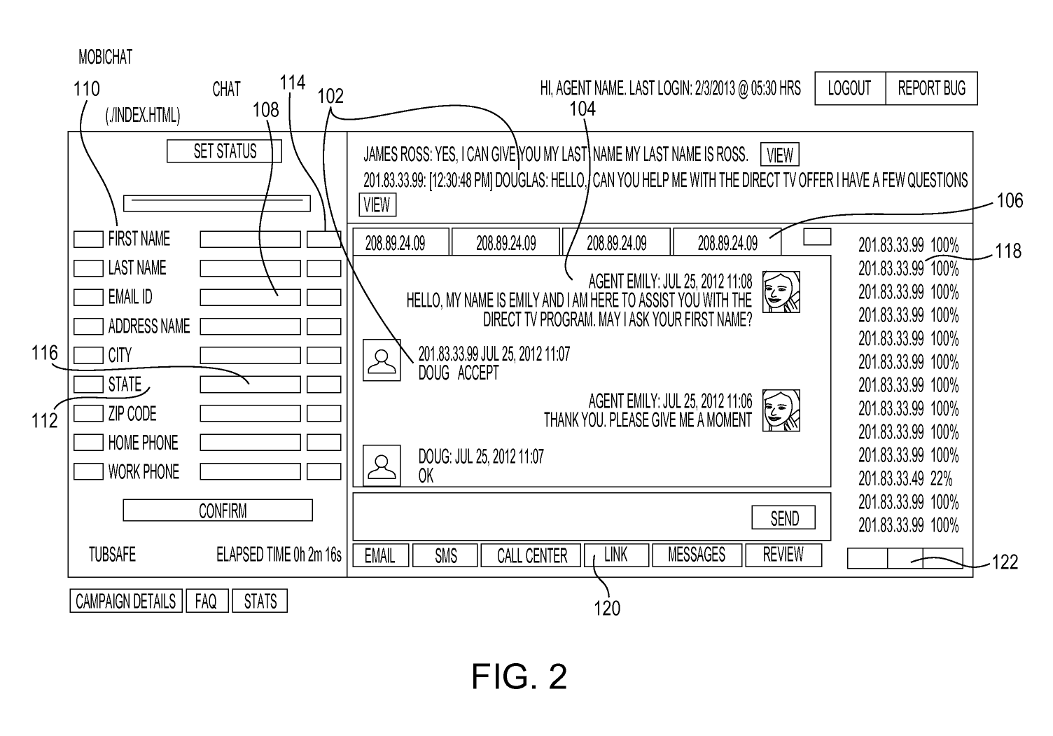

FIG. 2 shows an example of a product of one of the tools of the present invention. It is one of the possible screen shots for a computer monitor that is provided by the agent-portion of the “attended chat” software of the present invention. In this screen shot, the agent is able to see a quick review of the dialog or the textual inputs or the content 102 of the one or more text chats which the agent is conducting with multiple website visitors or mobile application users at any instant in time.

The agent is able to simultaneously conduct multiple chats because of, among other reasons, the considerable similarity in the chatters' inquires. This allows for the preparation of prepared, textual responses 104 to the more common of these inquires. Thus, an agent soon learns to anticipate certain inquires and is able to quickly use one of these prepared, textual responses to quickly respond—thereby, providing the agent with the time to then move on to serve a second or more website visitors while the first person with whom the agent is chatting reads and considers his most-recently-issued response.

The screen shot of FIG. 2 also shows, near its top and represented by clickable buttons, identifying information (e.g., website addresses) 106 of the various website visitors or others with whom an agent is generally chatting. This configuration is meant to aid an agent in quickly switching from one chat to another so as to not unduly delay any one of the agent's various simultaneous chats.

To further aid an agent in developing desired sales leads information, shown on the left side of one who is viewing the FIG. 2 screen shot is a reminder list or blanks for some of the contact information 108 that should be collected from the website visitors or others with whom an agent is chatting. When the desired information has been collected, the blanks are filled or completed. A quick look at this effective reminder list 110 and noting which items are not filled-in or completed easily gives an agent a status update 112 during a chat as to where he/she stands on the desired task of collecting this sales lead information.

Having the chat dialog 102, a effective reminder list 110 and therefore an effective status update 112 on the same screen helps an agent to stay on the task of being responsive to a chatter while also collecting the desired sales lead information. It has been found from experience that if the agent is not provided with these aides and sales lead collection tools that the desired task of collecting sales leads will never be accomplished as effectively as it might have been.

By examining FIG. 2 more closely, one can see many other unique features of this screen shot and the present invention's software that are directed at aiding an agent to be more productive. For example, to the left of the reminder list 110 are colored coded buttons/symbols or indicia whose colors change with time as a way to further update an agent as to the status of a chat with respect to collecting required sales lead information (e.g., green means the answer was validated and is correct, red means the answer was provided but did not pass validation, yellow means the chatter is taking longer 30 seconds to answer the question and thus alerting an agent to interject him/herself back into the chat).

Additionally, a chatter's lead-capture answers or input is shown to the agent in the filled-in blanks 108. A column of approval 114 and other buttons to the agent's right of these blanks allows an agent to individually edit and approve a chatter's answers or entries. If an answer does not look right to an agent, the agent has at his or her disposal a prepared question that can be sent to the chatter so as to try to resolve the agent's concern for the answer. This capability is provided even though algorithms in the software of the present invention provide for an automatic “style or format” validation of the inputted answers (e.g., an algorithm which checks the answer entered into a blank and, if a number appears in a blank where a name or noun is expected, invalidates the answer).

Also in this column of buttons are question 116 buttons that an agent can use to put forth a question to the chatter that is worded so as to elicit a response from the chatter that will supply the information needed to complete the blank to the left of the question button. This button allows the agent to manually ask a specific lead capture question of the chatter. The answer given will appear in the dialog and be used to populate the text field or blank related to the question asked.

Columns of information on the far right of this screen shot give a “sales lead” summary of the chats in which an agent is currently involved. Shown is a sales lead summary 118 button for each of the chatters and a percentage number that indicates what percentage of the many desired pieces of sales lead contact information have been elicited from a chatter and put into the system's database. By clicking on any one of the buttons, the agent's screen shot will be populated with the dialog box and sales lead information for that chatter associated with that button. These buttons can be quickly used by an agent to switch between their various ongoing chats.

A further column of information per chatter can be provided which indicates the elapsed time since the agent made his or her last input to each specific chat or chatter. The background lighting or other means associated with this information can be color coded or otherwise set so as to warn the agent when such elapsed times between agent inputs is such that it is likely to offend or possibly cause a problem for a chatter (e.g., green—elapsed time is within acceptable bounds, yellow—elapsed time is beginning to approach a problematic duration, red—the elapsed time is problematic and the agent owes the chatter more input as soon as possible); thereby, providing the agent with a “too long since last input” warning system.

At the bottom of the FIG. 2 screen shot are shown various productivity-aiding 120 buttons that an agent can push to aide his or her productivity or efficiency in responding to a chatter. These include: Email—click this it will show a list of email templates to send to a chatter; SMS—click this it will show a list of SMS templates to send to a chatter; Call Center—click this it will show a list of phone numbers which the agent can select to send to a chatter, with this input of the agent being shown in the dialog box 102 of the chatter to whom it was sent; Link—click this and it will show a list of URLs (e.g., specific product or other pages that may contain information being sought by a chatter or which could be helpful to a chatter) which the agent can select to send to a chatter; Messages/Answers—click this and it will show a list of common answers to questions that chatters often have; this button always proves to be a great time saver for an agent; Review—click this and the agent is able to see a screen that summarizes the sales lead information collected from a chatter; if this information looks reasonable to the agent, he/she can push another button to send this information to a chatter who is asked to review it and confirm whether it is accurate.

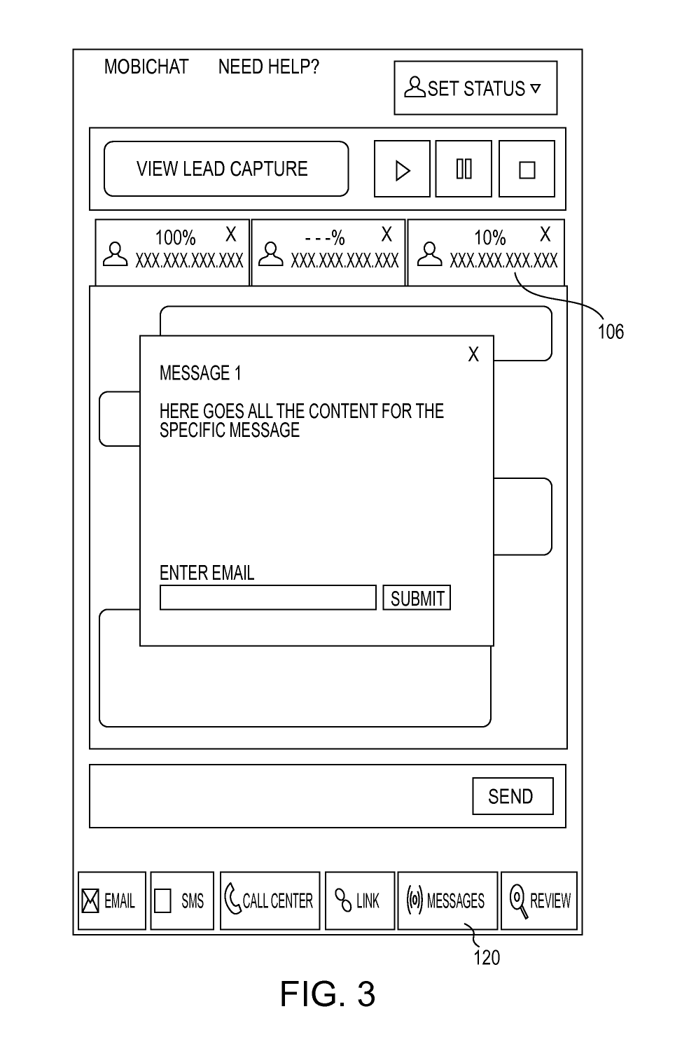

Since it is anticipated that some smart phone users will sometimes elect to not use their phone's web browser, but, instead, to communicate only with the “engagement service” provider by using their phone's mobile network and the use of text messages and emails, the present invention provides tools similar to those shown in FIG. 2 but which are configured for use by an agent whose computer device is the smaller display screen of a smart phone. See FIG. 3 for such a smart-phone screen shot.

It can be seen that an agent is again able to simultaneously conduct multiple chats by utilizing clickable buttons 106 with the identifying information (e.g., website addresses) of the various website visitors or others with whom an agent is generally chatting. Meanwhile, at the bottom of the FIG. 3 screen shot are shown various productivity-aiding 120 buttons that an agent can push to aide his or her productivity or efficiency in responding to a chatter (e.g., Email, SMS, Call Center, Link, Message and Review). A dialog box 102 is used to show the agent the text messages that comprise the current chat.

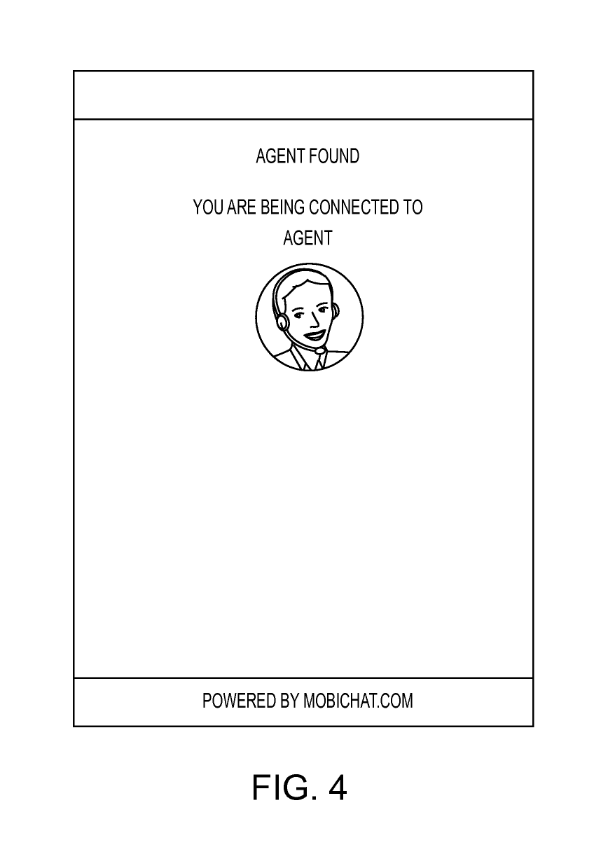

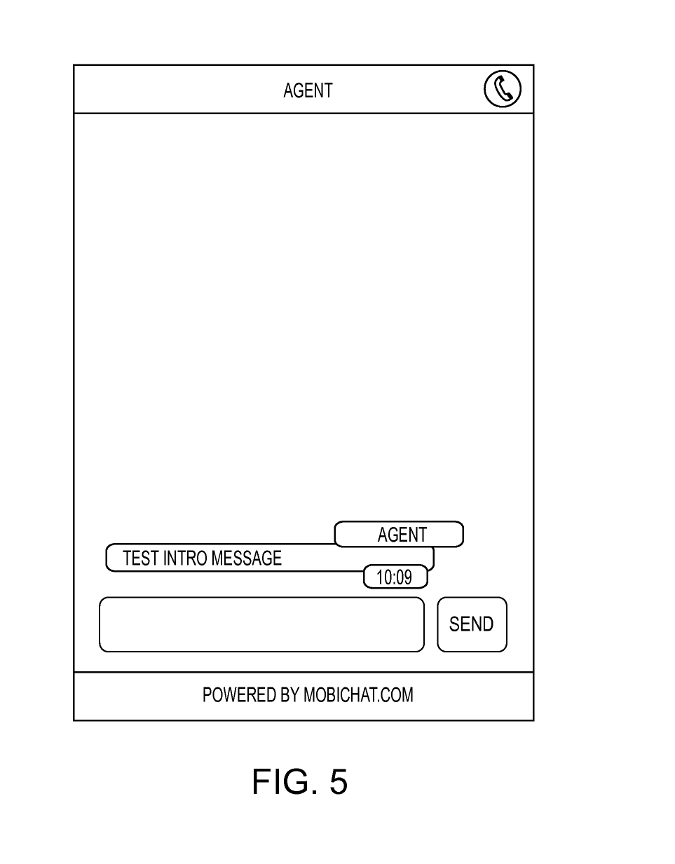

FIGS. 4-6 show examples of other products of one of the tools of the present invention. These are possible screen shots for the customer interface (CI) that a smart phone chatter sees on his/her phone video screen during such an “engagement service” encounter—it is provided by the customer-portion of the “attended chat” software of the present invention. In these screen shots, the customer is able to see that an “attended” chat is about to begin, and dialog boxes that include a standard text field in which the customer can input his/her text for such a chat, and also see the agent's responsive text input.

Additionally, to make such interfaces of the present invention as useful as possible, the software of the present invention has been also been configured to “recognize” certain textual inputs and to generate certain response actions or text messages from the service provider to the customer that attempt to make the resulting customer chats as efficient as possible. Example of these “recognized” inputs & the resulting system actions are:
Help—If a customer types this, the icon on the agent interface (AI) for this customer turns red and the chat tab for that customer blinks so as to alert an agent to be quickly attentive to this customer with whom an agent is chatting.
None—If a “minimum characters” box on the client or administrator interface (AdI) is set to zero, the question is not required—and the following text is automatically added to the end of the question: “Type None to skip;” thus, no agent interaction is required.
End—If the customer is answering a comment box question, the customer is advised to type END to denote the end of his/her answer and therefore discourage the practice of making comments that require multiple posts to input.
Number to Select an Answer to a Multiple Choice Question—the customer sees the entire question with responses next to them, and the customer only needs to enter in the number associated with the selected response.
Yes/No questions put forth by an agent are followed by Yes or No boxes which the customer can check to respond.

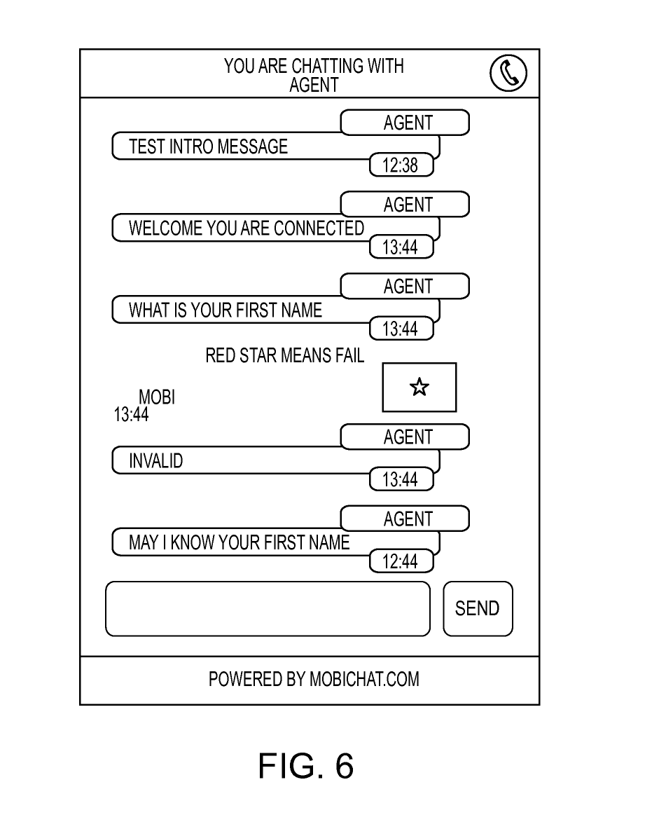

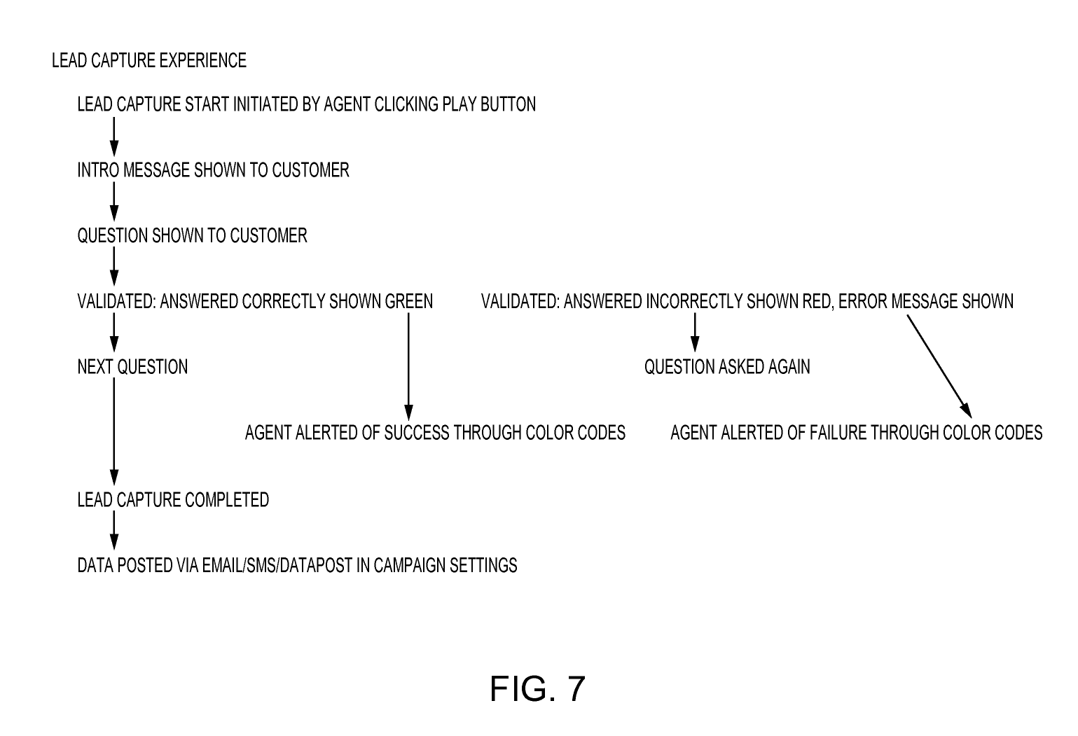

FIG. 7 is a flow diagram that generally illustrates how the software of the present invention works to make the agents of “engagement service” providers more productive by better enabling them to efficiently collect sales lead information for the product and service providers who are the clients of the “online engagement” service providers. The sales lead capture process begins by an agent who is chatting with an interested party assessing that a time has come in the chat when the agent may ask the question of whether the chatter would be willing to answer a few background questions whose answers would be enable the agent to be of service to the chatter. If the chatter answers affirmatively, the agent can push the appropriate one of the “lead capture status” 122 buttons (i.e., the Start button) seen in the bottom right corner of the screen shot shown in FIG. 2 to activate the agent's tools that will help and guide the collection of the desired information. An initial introductory message is usually shown to a chatter and then an initial text question is shown to the chatter, see FIG. 6. Answers are provided and immediately automatically validated for style, etc. (e.g., if the answer is supposed to be a proper name, this validation may be set to reject any answer that contains a “number”) before a next question is asked, see FIG. 6. Once all the necessary questions have been satisfactorily answered so as to yield a complete sales lead, this information is stored in the present invention's database before being send onto the client or product or service provider who has contracted with the “engagement service” provider for the collection of this information.

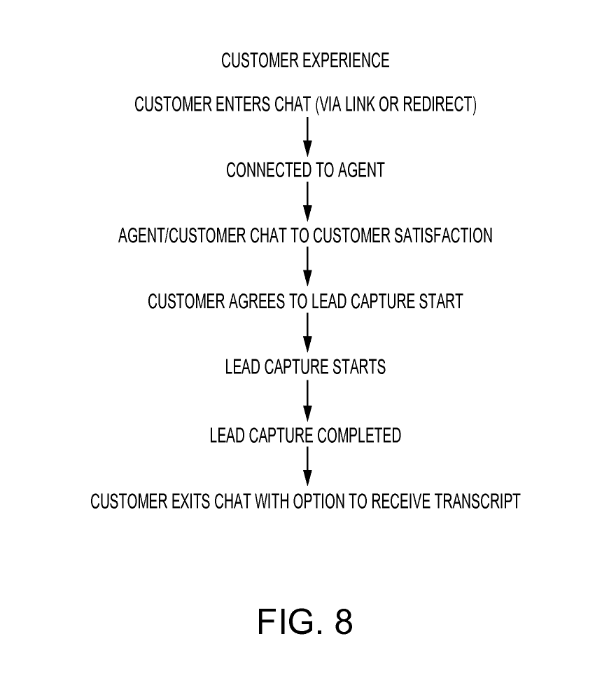

FIG. 8 provides a comparable flow diagram which shows the various steps in this lead generation process from the perspective of the chatter or potential customer for the service's product and service providers.

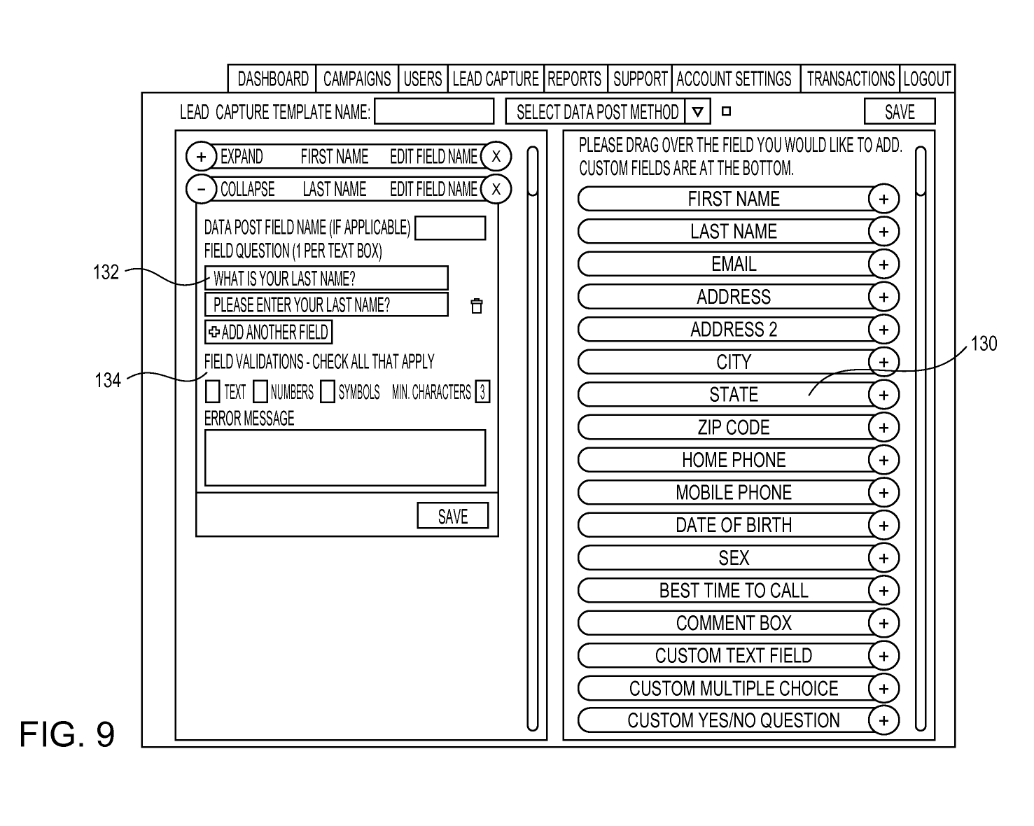

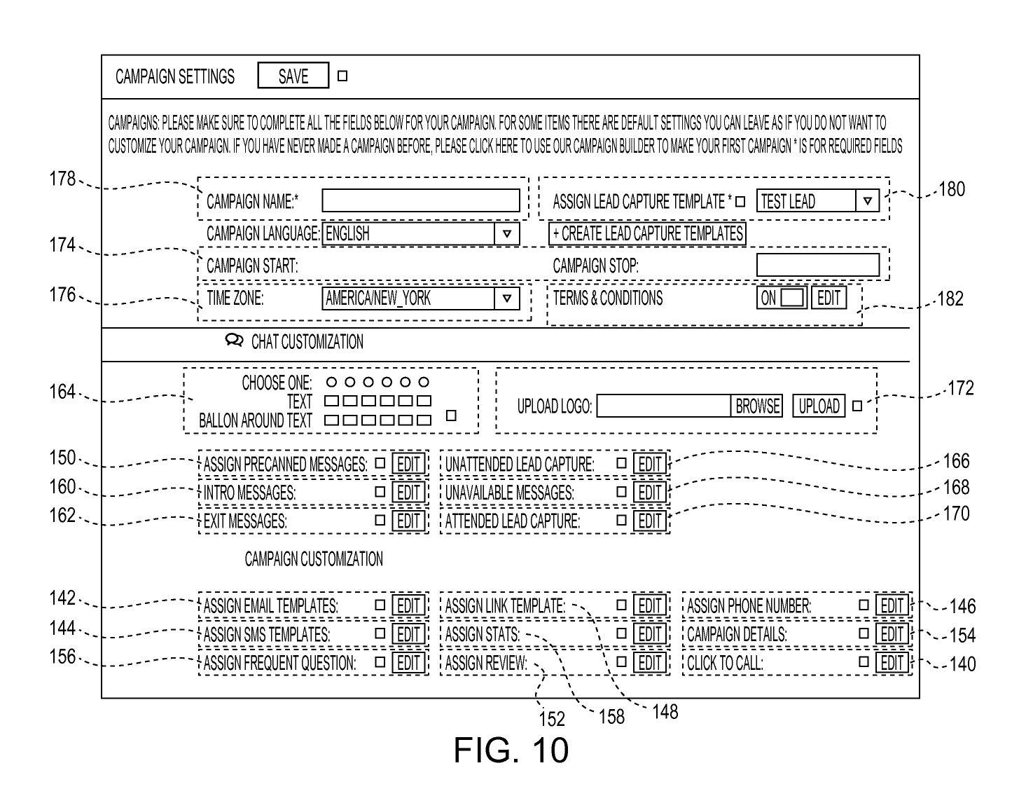

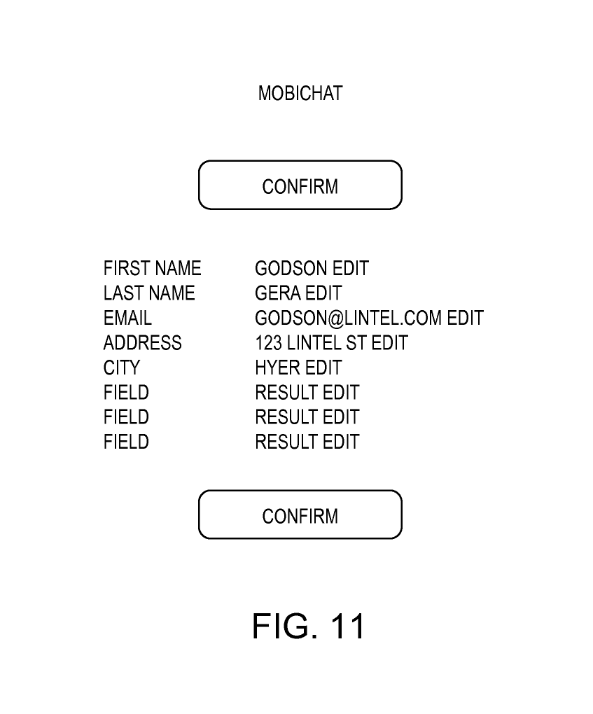

FIGS. 9 and 10 show examples of other products of one of the tools of the present invention that is useful in this same area—i.e., collecting sales leads or similar background information on a customer or chatter. In these instances, the computer-monitor, screen shots are not meant communicating with an agent or customer, but are administrator- or client-interface (AdI) screen shots that are for aiding a client or system administrator who is setting up or customizing the tools that will be used in a specific sales lead generation campaign. Since significantly different type of campaigns will possibly be warranted for widely different products and services, the administrator-portion of the software of the present invention has been configured so as to enable to client to interact with various screen shots so as to customize the campaign that he will engage the “engagement service” provider to conduct for the product or service supplier.

FIG. 9 shows a screen shot of a tool of the present invention that can be used by clients of the “engagement service” provider to create customized contact information fields 108. This screen shot shows, on its right side, a listing 130 of suggested pieces of information that could be obtained from a chatting website visitor or other and which can be used to define a particular or customized sales lead. Dragging one of these listings from the right to the left side of the screen automatically causes a number of prepared, textual questions 132 to be listed on the left side of the screen under the blank for the contact information being sought. Shown towards the bottom left of this same screen shot is what is referred to herein as the tools for automatically validating stylistically 134 a chatter's textual input. This automatic “style or format” validation (e.g., when an expected input is in the form of a name or noun, an automated check is made to ensure that a certain number of non-similar “letter” characters are inputted) is an important aspect of the present invention as it plays a significant part in determining the applicability, validity and usefulness of the possible sales leads that are created using the present invention.

FIG. 10 shows another AdI screen shot of the present invention that is for use by individual clients to create, for their personalized sales lead generation campaigns, the customized date fields that will be used in the screen shots for the customer and agent interfaces of such campaigns. It can be seen in FIG. 10 that by clicking “edit” in the appropriate box, a client is given the option to add different types of information or design elements in either the “customer-” or “agent-” interface screen shots that are generated by the software of the present invention. Some of these many types of information and design elements for these screen shots include:

140—Click To Call—assign a phone number for customers to use when they click the phone icon that is subsequently created in a “customer interface” screen shot (CI),

142—Assign Email Templates—assign and create email templates which are then provided for the agent to use by clicking the “email” icon in the “agent interface” screen shot (AI),

144—Assign SMS Templates—assign and create SMS templates which are then provided for the agent to use by clicking SMS in the AI,

146—Assign Phone Number—assign and create phone numbers in the AI which the agent can use by clicking the call center button and selecting which phone number to paste into a specific chat,

148—Assign Link Template—assign and create hyperlinks which the agent can use by clicking in the AI a link button and selecting which to paste into a chat,

150—Assigned Precanned Messages—assign and create groups of text messages which can be used by the agent to answer common questions; the messages are available by clicking messages in the AI,

152—Assign Campaign Pixel—sends a server ping to the client URL to inform the client that a 100% lead capture has been completed,

154—Campaign Details—these are general details shown in the AI regarding the campaign which are provided for the agent to use while communicating/chatting; they can only be changed in one of the screen shots created for a client to use in setting up a campaign,

156—Assign Frequent Questions—these are questions created by a client for use by the agent and a pop-down menu of them are listed in the AI,

158—Stats—this tab in an AI will show basic stats on the campaign for that particular agent; it is used by the agent for assessing their performance,

160—Intro Message—this allows a client to create a custom introductory message which is automatically shown on the CI when a customer enters a chat,

162—Exit Message—this allows a client to create an exit message to be shown on the CI when the agent leaves the chat before the customer,

164—Color Scheme—this is a custom option set by the client which allows them to choose what color the text is in the CI; the client also can change the outline color of the bubble which surrounds the text,

166—Unattended Lead Capture Message—this option allows a client to use a standardized message and CI page that is shown to the customer when he/she has decided to take part in a lead capture even though the campaign is, for example, outside its normal hours; this message is shown once a customer enter a chat much like the previously mentioned introductory message; an example message would be “Sorry that no one is available to personally speak with you; however, you can still be helped if you will participate in the following dialogue and answer the forthcoming questions,”

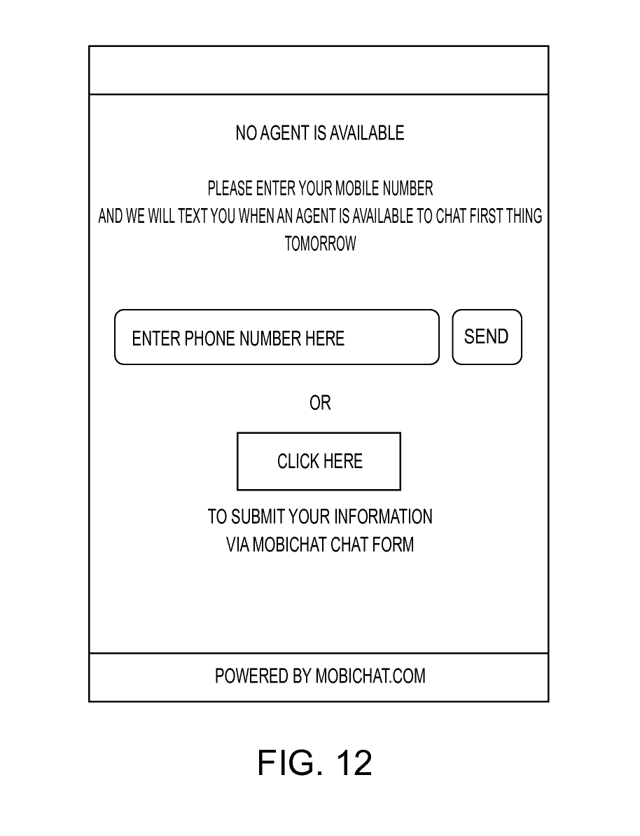

168—Unavailable Lead Capture Message—the client can create this message to be shown when the customer has decided to take part in a lead capture even though no agent is available; see FIG. 12, this message is played during normal campaign hours but there is no agent with whom to speak; an example message would be “Sorry no agents are available to assist you right away—please answer the following questions as accurately as you can and while you are answering, an agent may become available to help you,”

170—Attended Lead Capture Message—the client can create this message to be shown on the CI during normal business when an agent is available to chat with a customer; an example message might be “Please answer the following questions—if at any time you have a question or need help, please type help and the agent will respond right away,”

172—Upload Logo—the client is able to insert their logo on the CI,

174—Campaign Start/Stop—the client identifies the start and stop times to be used their campaign—during this time agents normally will be available and, if they are not, the CI will display an “unavailable” message and offer the customer the option for an SMS unattended chat that results in the customer participating in an automated chat that enable the customer to enter their contact information into the campaign's database,

176—Time Zone—the client has the option of identifying the time zone to which the start and stop times refer,

178—Campaign Name—the client can give the campaign a name,

180—Assign Lead Capture Template—the client has the option of selecting the various CI screen shot templates that are to be used during a campaign, and

182—Terms and Conditions—the client has the option of inserting onto the CI various “terms and conditions” that the client elects to apply to a campaign.

While the above disclosure has concentrated on smart phone users, it should be noted that an obvious variant of the present invention is to configure its software so that it can also provide such “engagement services” to desktop, internet-accessible computer users.

Meanwhile, extending the provision of “engagement services” from the standard desktop, internet-accessible computer to mobile devices has also presented special technical challenges for the present invention. These have required the configuration of the software of the present invention to meet the challenges of: (1) the more frequent dropping of connections with mobile communications, which required that the technology for mobile chats be engineered so as to enable seamless reconnections, (2) since managing multiple windows can be difficult on mobile devices, chat windows have been configured so that they are an integral part of a “wireless portals” or a mobile application, and (3) since traditional, URL-based hyperlinks cannot be used in mobile applications, new programming solutions were implemented to enable agents to direct those with whom they are chatting to specific parts of a mobile application without using URL-based hyperlinks.

Finally, it should be noted that the foregoing is considered as illustrative only of the principles of the present invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention that are set forth in the claims to the invention.

1. An improved method, performed by a networked computing device having a display monitor, of providing engagement services to smart phone users that yield improved rates of customer conversions for a business entity or client who advertises products or services to said smart phone users, said method of the type that enables a smart phone user to have a chat dialog with a live agent of said business entity by utilizing the video screens of the smart phones of said smart phone users, said method comprising the steps of:
providing a customer-interface, that appears on said video screen of said smart phones, having a configuration that aids said smart phone user in participating in said chat dialog with said live agent,
providing an agent-interface, that appears on said display monitor of said networked computing device,
formulating wherein a portion of said chat dialog of said live agent so as to cause said smart phone user to provide the contact information of said smart phone user,
validating said contact information provided by said smart phone user in a time frame that enables the further formulation of a later portion of said chat dialog of said live agent so as to cause said smart phone user to provide additional contact information for said smart phone user,
enabling said display monitor of said networked computing device to perform the function of providing said live agent on a single display screen for each of a plurality of said smart phone users with whom said live agent is substantially seamlessly participating in a chat dialog:
(a) indicia that individually identifies all of said plurality of said smart phone users with whom said live agent is substantially seamlessly participating in a chat dialog,
(b) a reminder list of said contact information that is to be collected from each of said plurality of said smart phone users,
(c) indicia that indicates where said live agent stands in relation to having completed the task of collecting said desired contact information from each of said plurality of said smart phone users with whom said live agent is substantially seamlessly chatting,
(d) indicia that indicates a smart shone user with whom said live a ent is chatting has taken longer than a prescribed time period to answer an outstanding question that said live agent has presented to said smart phone user and thereby alerts said live agent to take a remedial action, and
(e) a plurality of color-coded indicators, each of which is associated with one of said plurality of said smart phone users with whom said live agent is substantially seamlessly participating in a chat dialog and is illuminated in such a manner so as to warn said live agent that the elapsed time since said live agent last inputted into the chat dialog with said smart phone user is likely to be problematic for this smart phone user.

2. The improved method as recited in claim 1, further comprising the steps of:
further enabling said display monitor of said networked computing device to perform the function of showing said live agent on a single display screen for each of a plurality of said smart phone users with whom said live agent is substantially seamlessly participating in a chat dialog:
(f) see indicia that informs said live agent of the elapsed time since said live agent made an input into said chat dialogs with said smart phone user,
(g) a plurality of productivity-enhancing, tools that enables said live agent to enhance the efficiency and productivity of said live agent in conducting said substantially seamlessly chat dialogs and wherein said productivity-enhancing, tools chosen from the group including templates for email, phone numbers, web addresses, and answers to common customer service questions, and
(h) a means for sending said smart phone user, as a part of said chat dialog, a summary text of the collected contact information of said smart phone user for the review and accuracy confirmation of said smart phone user.

3. The improved method as recited in claim 1, further comprising the step of:
enabling a client to customize said portion of said chat dialog of said live agent formulated so as to cause said smart phone user to provide the contact information of said smart phone user.

4. The improved method as recited in claim 2, further comprising the step of:
enabling a client to customize said portion of said chat dialog of said live agent formulated so as to cause said smart phone user to provide the contact information of said smart phone user.

5. The improved method as recited in claim 1, further comprising the steps of:
enabling a client to customize a campaign that is conducted using said method to collect said contact information from a plurality of said smart phone users.

6. The improved method as recited in claim 2, further comprising the steps of:
enabling a client to customize a campaign that is conducted using said method to collect said contact information from a plurality of said smart phone users.

7. The improved method as recited in claim 3, further comprising the steps of:
enabling a client to customize a campaign that is conducted using said method to collect said contact information from a plurality of said smart phone users.

8. The improved method as recited in claim 4, further comprising the steps of:
enabling a client to customize a campaign that is conducted using said method to collect said contact information from a plurality of said smart phone users.

9. A non-transitory, computer-readable medium storing instructions that, when executed, enable a networked computing device having a display monitor to provide engagement services to smart phone users that yield improved rates of customer conversions for a business entity or client who advertises products or services to said smart phone users, said engagement services of the type that enable a smart phone user to have a chat dialog with a live agent of said business entity by utilizing the video screens of the smart phones of said smart phone users, said instructions on said medium comprising the steps of:
providing a customer-interface, that appears on said video screen of said smart phones, having a configuration adapted to aid said smart phone user in participating in said chat dialog with said live agent,
providing an agent-interface, that appears on said display monitor of said networked computing device,
formulating a portion of said chat dialog of said live agent so as to cause said smart phone to provide the contact information of said smart phone user,
validating said contact information provided by said smart phone user in a time frame that enables the further formulation of a later portion of said chat dialog of said live agent so as to cause said smart phone user to provide additional contact information for said smart phone user,
enabling said display monitor of said networked computing device to perform the function of providing said live agent on a single display screen for each of a plurality of said smart phone users with whom said live agent is substantially seamlessly participating in a chat dialog:
(a) indicia that individually identifies all of said plurality of said smart phone users with whom said live agent is substantially seamlessly participating in a chat dialog,
(b) a reminder list of said contact information that is to be collected from each of said plurality of said smart phone users,
(c) indicia that indicates where said live agent stands in relation to having completed the task of collecting said desired contact information from each of said plurality of said smart phone users with whom said live agent is substantially seamlessly simultaneously chatting, and
(d) indicia that indicates when a smart phone user with whom said live agent is chatting has taken longer than a prescribed time to answer an outstanding question that said live agent has presented to said smart phone user and thereby alerts said live agent to take a remedial action, and
(e) a plurality of color-coded indicators, each of which is associated with one of said plurality of said smart phone users with whom said live agent is substantially seamlessly participating in a chat dialog and is illuminated in such a manner so as to warn said live agent that the elapsed time since said live agent last inputted into the chat dialog with said smart phone user is likely to be problematic for this smart phone user.

10. The non-transitory, computer-readable medium storing instructions as recited in claim 9, said instructions on said medium further comprising the steps of:
further enabling said display monitor of said networked computing device to perform the function of providing said live agent on a single display screen for each of a plurality of said smart phone users with whom said live agent is substantially seamlessly participating in a chat dialog:
(f) indicia that informs said live agent of the elapsed time since said live agent made an input into said chat dialogs with said smart phone user,
(g) a plurality of productivity-enhancing, tools that enables said live agent to enhance the efficiency and productivity of said live agent in conducting said substantially seamlessly chat dialogs and wherein said productivity-enhancing, tools chosen from the group including templates for email, phone numbers, web addresses, and answers to common customer service questions, and
(h) a means for sending said smart phone user, as a part of said chat dialog, a summary text of the collected contact information of said smart phone user for the review and accuracy confirmation of said smart phone user.

11. The non-transitory, computer-readable medium storing instructions as recited in claim 9, said instructions on said medium further comprising the step of:
providing a client with the ability to customize said portion of said chat dialog of said live agent formulated so as to cause said smart phone user to provide the contact information of said smart phone user.

12. The non-transitory, computer-readable medium storing instructions as recited in claim 10, said instructions on said medium further comprising the step of:
providing a client with the ability to customize said portion of said chat dialog of said live agent formulated so as to cause said smart phone user to provide the contact information of said smart phone user.

13. The non-transitory, computer-readable medium storing instructions as recited in claim 9, said instructions on said medium further comprising the steps of:
providing a client with the ability to customize a campaign that is conducted using said engagement services to collect said contact information from a plurality of said smart phone users.

14. The non-transitory, computer-readable medium storing instructions as recited in claim 10, said instructions on said medium further comprising the step of:
providing a client with the ability to customize a campaign that is conducted using said engagement services to collect said contact information from a plurality of said smart phone users.

15. The non-transitory, computer-readable medium storing instructions as recited in claim 11, said instructions on said medium further comprising the step of:
providing a client with the ability to customize a campaign that is conducted using said engagement services to collect said contact information from a plurality of said smart phone users.

16. The non-transitory, computer-readable medium storing instructions as recited in claim 12, said instructions on said medium further comprising the step of:
providing a client with the ability to customize a campaign that is conducted using said engagement services to collect said contact information from a plurality of said smart phone users.

17. (canceled)

18. (canceled)

19. (canceled)

20. (canceled)
